(19) United States
(12) Patent Application Publication
(10) Pub. No.: US 2006/0147771 A1
(43) Pub. Date: Jul. 6, 2006

(54) Fuel cell system with independent reformer temperature control

(75) Inventors: Ian Russell, Sunnyvale, CA (US); Wilhelmus Kuilboer, Mount Eliza (AU); Martin Perry, Sunnyvale, CA (US); Swaminathan Venkataraman, Cupertino, CA (US)

Correspondence Address: FOLEY AND LARDNER LLP;SUITE 500, 3000 K STREET NW, WASHINGTON, DC, 20007, US

(73) Assignee: ION AMERICA CORPORATION

(21) Appl. No.: 11/028,506

(22) Filed: Jan. 4, 2005

(51) Int. Cl. H01M 8/04; H01M 8/06; H01M 8/24; H01M 8/12

(52) U.S. Cl. 429/24; 429/20; 429/32; 429/17

(57) ABSTRACT

A fuel cell system includes a plurality of fuel cell stacks, a plurality of reformers, and a plurality of combustors. Each reformer is adapted to reform a hydrocarbon fuel to a hydrogen containing reaction product and to provide the reaction product to at least one of the plurality of the fuel cell stacks. Each combustor is thermally integrated with at least one of the plurality of the reformers. The system also includes an independent fuel feed conduit provided into each combustor and one or more control devices adapted to independently control an amount of fuel being provided to each combustor through each fuel feed conduit to independently control a temperature of each combustor.

### BACKGROUND OF THE INVENTION

The present invention is generally directed to fuel cells and more specifically to fuel cell systems and their operation.

Fuel cells are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as the solid oxide regenerative fuel cells, that also allow reversed operation, such that oxidized fuel can be reduced back to unoxidized fuel using electrical energy as an input.

In a high temperature fuel cell system such as a solid oxide fuel cell (SOFC) system, an oxidizing flow is passed through the cathode side of the fuel cell while a fuel flow is passed through the anode side of the fuel cell. The oxidizing flow is typically air, while the fuel flow is typically a hydrogen-rich gas created by reforming a hydrocarbon fuel source. The fuel cell, operating at a typical temperature between 750° C. and 950° C., enables the transport of negatively charged oxygen ions from the cathode flow stream to the anode flow stream, where the ion combines with either free hydrogen or hydrogen in a hydrocarbon molecule to form water vapor and/or with carbon monoxide to form carbon dioxide. The excess electrons from the negatively charged ion are routed back to the cathode side of the fuel cell through an electrical circuit completed between anode and cathode, resulting in an electrical current flow through the circuit.

### BRIEF SUMMARY OF THE INVENTION

The preferred aspects of present invention provide a fuel cell system, comprising a plurality of fuel cell stacks, a plurality of reformers, and a plurality of combustors. Each reformer is adapted to reform a hydrocarbon fuel to a hydrogen containing reaction product and to provide the reaction product to at least one of the plurality of the fuel cell stacks. Each combustor is thermally integrated with at least one of the plurality of the reformers. The system further comprises an independent fuel feed conduit provided into each combustor and one or more control devices adapted to independently control an amount of fuel being provided to each combustor through each fuel feed conduit to independently control a temperature of each combustor.

### BRIEF DESCRIPTION OF THE DRAWINGS

FIGS. 1A and 1B are schematic side cross sectional views of systems of the preferred embodiments of the present invention.

FIGS. 2A and 3A are top cross sectional views of portions of the system of FIG. 1B.

FIGS. 2B and 3B are side cross sectional views of portions of the system of FIG. 1B which correspond to the portions shown in FIGS. 2A and 3A, respectively.

FIG. 4A is a top cross sectional view of a portion of the system of FIG. 1A.

FIG. 4B is a side cross sectional view of a portion of the system of FIG. 1A, which corresponds to the portion shown in FIG. 4A.

### DETAILED DESCRIPTION OF THE PREFERRED EMBODIMENTS

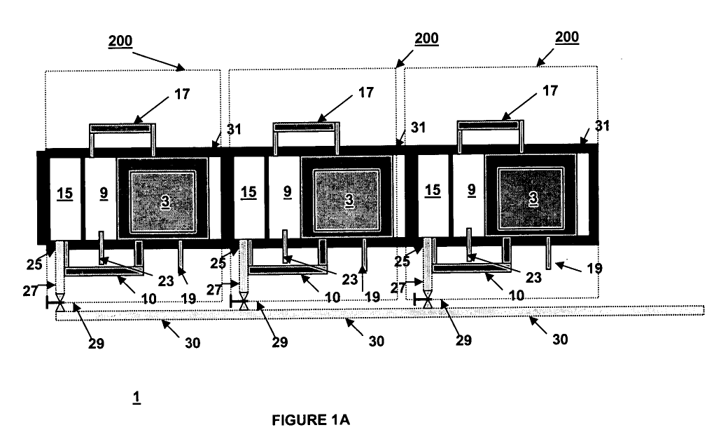

FIG. 1A illustrates a fuel cell system 1 according to a first preferred embodiment of the invention. Preferably, the system 1 is a high temperature fuel cell stack system, such as a solid oxide fuel cell (SOFC) system or a molten carbonate fuel cell system. However, the system 1 may also comprise other fuel cell systems that utilize a reformer. The system 1 may be a regenerative system, such as a solid oxide regenerative fuel cell (SORFC) system which operates in both fuel cell (i.e., discharge) and electrolysis (i.e., charge) modes or it may be a non-regenerative system which only operates in the fuel cell mode.

The system 1 contains a plurality of high temperature fuel cell stacks 3. Each of the stacks 3 may contain a plurality of SOFCs, SORFCs or molten carbonate fuel cells. Each fuel cell contains an electrolyte, an anode electrode on one side of the electrolyte in an anode chamber, a cathode electrode on the other side of the electrolyte in a cathode chamber, as well as other components, such as separator plates/electrical contacts, seals, fuel cell housing and insulation. In a SOFC operating in the fuel cell mode, the oxidizer, such as air or oxygen gas, enters the cathode chamber, while the fuel, such as hydrogen and/or hydrocarbon fuel, enters the anode chamber. Any suitable fuel cell designs and component materials may be used.

The system 1 also contains a plurality of reformers 9 and combustors 15. Each reformer 9 is adapted to reform a hydrocarbon fuel to a hydrogen containing reaction product and to provide the reaction product to a fuel cell stack 3. Each combustor 15 is preferably thermally integrated with one or more of the plurality of the reformers 9 to provide heat to the reformers 9. The term “thermally integrated” in this context means that the heat from the reaction in the combustor 15 drives the net endothermic fuel reformation in one or more reformers 9.

The cathode exhaust outlet 10 of each fuel cell stack 3 is preferably operatively connected to an inlet 25 of at least one combustor 15 to provide an oxidizer, such as hot air, into the combustor 15. Humidified fuel is provided in each reformer through a respective fuel inlet conduit 23. Furthermore, each of a plurality of hydrocarbon fuel sources or feeds 27 is also operatively connected to a respective combustor 15 inlet 25. Preferably, each inlet 25 of each combustor 15 is connected to a separate hydrocarbon fuel source or feed conduit 27. Each reformer 9 is operatively connected to a respective stack 3 anode inlet via a conduit 17 to provide a reformed product or fuel into each stack 3. Air is provided into each stack 3 through a cathode inlet 19.

The term “operatively connected” means that components which are operatively connected may be directly or indirectly connected to each other. For example, two components may be directly connected to each other by a fluid (i.e., gas and/or liquid) conduit. Alternatively, two components may be indirectly connected to each other such that a fluid stream passes between the first component to the second component through one or more additional components of the system.

The system 1 also contains one or more control devices 29 adapted to independently control an amount of fuel being provided to each combustor through each fuel feed conduit 27 to independently control a temperature of each combustor 15. The independent control of a temperature of each combustor 15 provides independent control of an amount of heat provided to each thermally integrated reformer 9, which in turn provides an independent control of a temperature of each thermally integrated reformer 9. Furthermore, the independent control of a temperature of each reformer 9 provides independent control of a temperature of each associated stack 3 which receives the reaction product from the controlled reformer 9. In other words, by independently controlling the fuel flow to the combustors 15, the temperature of each associated reformer 9 and stack 3 may also be independently controlled.

The one or more control devices 29 may comprise one or more flow controllers, such as fuel flow control valves, that are adapted to control fuel flow into each fuel feed conduit. Preferably, each flow controller valve 29 is located in each of the plurality of the fuel feed conduits 27. The valves 29 may be controlled manually by an operator or automatically controlled by a control system, such as a computer or another electronic control system. If desired, instead of multiple valves 29, a single, centrally located flow control device, such as a multi-outlet valve, may be used to independently control the fuel flow into each of the fuel feed conduits 27 from one or more fuel supply conduits 30 or fuel tanks.

Preferably, one or more sensors are located in the system 1 which are used to determine if one or more reformers 9 require additional heat and/or how much additional heat is required. These sensors may be reformer temperature sensor(s) which measure the reformer temperature and/or process parameter sensor(s), which measure one or more of fuel utilization, stack efficiency, heat loss and stack failure/turndown. The output of the sensor(s) is provided to a computer or other processor and/or is displayed to an operator to determine if and/or how much additional heat is required by each reformer. The processor or operator then independently controls each combustor's heat output based on the step of determining to provide a desired amount heat from the controlled combustor to the desired reformer.

The hydrocarbon fuel reformers 9 may be any suitable devices which are capable of partially or wholly reforming a hydrocarbon fuel to form a carbon containing and free hydrogen containing fuel. For example, each fuel reformer 9 may be any suitable device which can reform a hydrocarbon gas into a gas mixture of free hydrogen and a carbon containing gas. For example, the fuel reformer 9 may reform a humidified biogas, such as natural gas, to form free hydrogen, carbon monoxide, carbon dioxide, water vapor and optionally a residual amount of unreformed biogas by a steam methane reformation (SMR) reaction. The free hydrogen and carbon monoxide are then provided into the fuel inlet of one or more the fuel cell stacks 3 which are operatively connected to each reformer.

Preferably, each fuel reformer 9 is thermally integrated with one or more of the fuel cell stacks 3 to support the endothermic reaction in the reformer 9 and to cool the stack or stacks 3. The term “thermally integrated” in this context means that the heat from the reaction in the fuel cell stack 3 drives the net endothermic fuel reformation in the fuel reformer 9. The fuel reformer 9 may be thermally integrated with one or more fuel cell stacks 3 by placing the reformer and stack(s) in the same hot box 31 and/or in thermal contact with each other, or by providing a thermal conduit or thermally conductive material which connects the stack(s) to the reformer.

As shown in FIG. 1A, each reformer 9 is preferably located in close proximity to at least one stack 3 to provide radiative and convective heat transfer from the stack 3 to the reformer. Preferably, the cathode exhaust conduit of each stack 3 is in direct contact with a respective reformer 9. For example, one or more walls of each reformer 9 may comprise a wall of the stack cathode exhaust conduit 10 of the adjacent stack 3. Thus, each stack's cathode exhaust provides convective heat transfer from each stack 3 to one or more adjacent reformers 9.

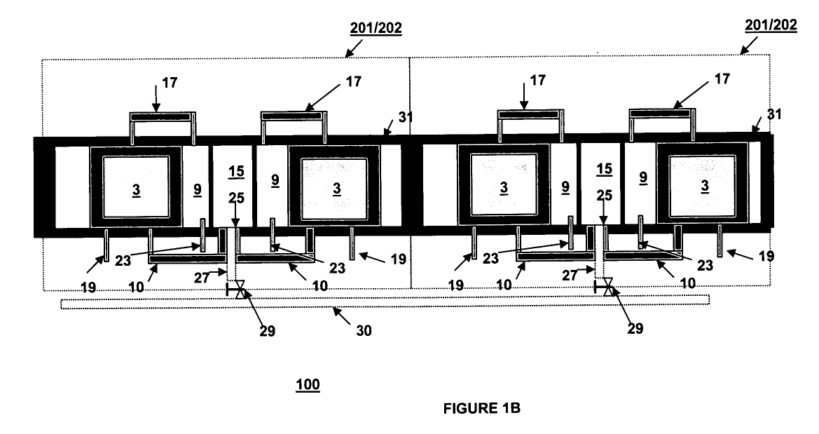

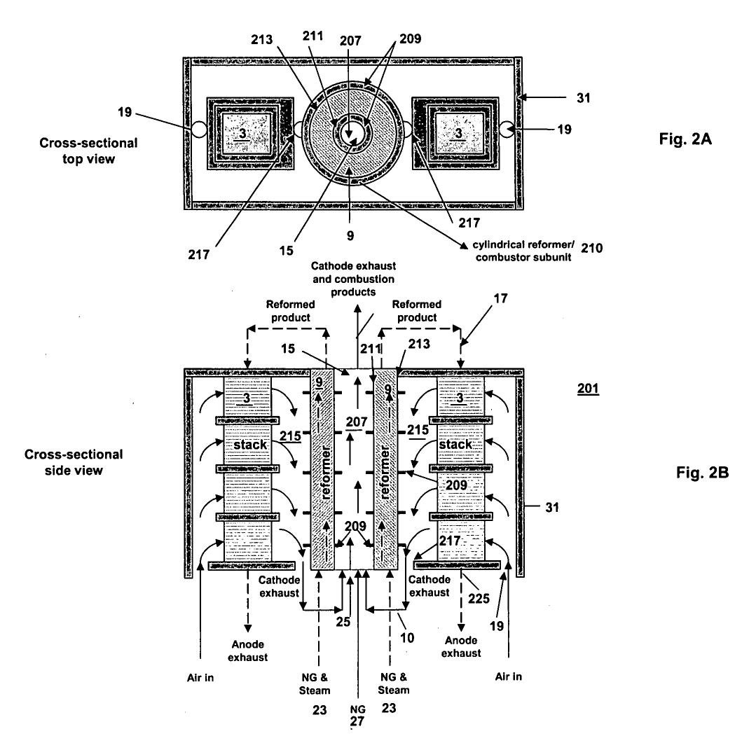

Furthermore, if desired, the cathode exhaust from each stack 3 may be wrapped around the adjacent reformer 9 by proper ducting and fed to the combustion zone of the combustor 15 adjacent to the reformer 9, as shown in FIGS. 2-4 and as described in more detail below.

The combustors 15 provide a supplemental heat to one or more reformers 9 to carry out the SMR reaction during steady state operation. Each combustor 15 may be any suitable burner which is thermally integrated with one or more reformers 9. Each combustor 15 receives the hydrocarbon fuel, such as natural gas, and the stack 3 cathode exhaust stream through inlet 25. However, if desired, another source of oxygen or air may be provided to the combustor 15 in addition to or instead of the stack cathode exhaust stream. For example, an air blower may be used to provide room temperature or preheated air into the combustor 15 inlet 25. The fuel and the source of oxygen, such as the hot air from the cathode exhaust stream, are combusted in the combustor to generate heat for heating one or more reformers 9. The combustor outlet may be operatively connected to a heat exchanger to heat one or more incoming streams provided into the fuel cell stacks, if desired.

Preferably, the supplemental heat to each reformer 9 is provided from a combustor 15 which is operating during steady state operation of the reformer (and not just during start-up) and from the cathode (i.e., air) exhaust stream of the stack 3. When no heat is required by the reformer, the combustor unit acts as a heat exchanger. Thus, the same combustor 15 may be used in both start-up and steady-state operation of the system 1.

Most preferably, the combustor 15 is in direct contact with one or more reformers 9, and the stack 3 cathode exhaust is configured such that the cathode exhaust stream contacts one or more reformers 9 and/or wraps around the reformer(s) 9 to facilitate additional heat transfer. This lowers the combustion heat requirement for SMR. Preferably, each reformer 9 is sandwiched between one combustor 15 and one or more stacks 3 to assist heat transfer. However, if desired, a plurality of combustors 15 may be used to heat each reformer 9.

As shown in FIG. 1A, the system 1 preferably contains a plurality of units 200, each of which is located in a separate hot box or container 31. Each unit 200 contains one stack 3, one reformer 9 and one combustor 15. FIG. 1B illustrates a system 100 according to alternative embodiment of the present invention. The system 100 is similar to system 1, except that in the system 100, each hot box or container 31 contains a unit 201/202 comprising more than one stack 3 and/or more than one reformer 9. Preferably, but not necessarily, each unit 201/202 contains one combustor 15. The details of each unit 200, 201 and 202 will be described in more detail below with respect to FIGS. 2, 3 and 4.

FIGS. 2-4 illustrate three exemplary configurations of one of a plurality of stack, reformer and combustor units of FIGS. 1A and 1B in the hot box 31. However, other suitable configurations are possible. The reformer 9 and combustor 15 shown in FIGS. 2-4 preferably comprise vessels, such as fluid conduits, that contain suitable catalysts for SMR reaction and combustion, respectively. The reformer 9 and combustor 15 may have gas conduits packed with catalysts and/or the catalysts may be coated on the walls of the reformer 9 and/or the combustor 15.

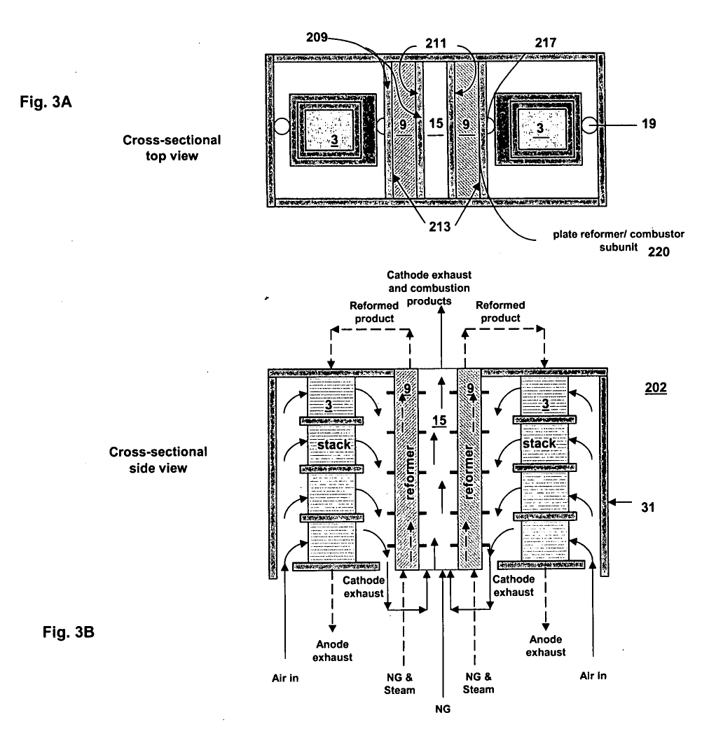

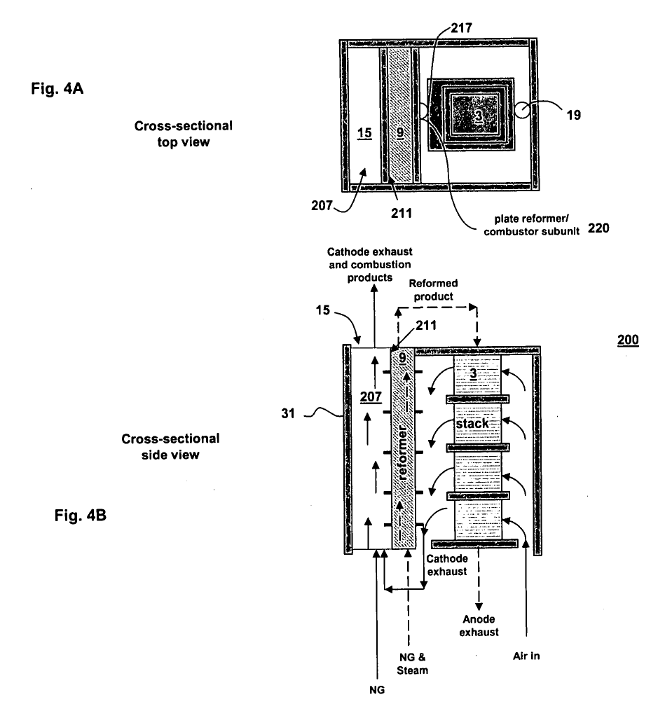

The reformer 9 and combustor 15 unit can be of cylindrical type, as shown in FIG. 2A or plate type as shown in FIGS. 3A and 4A. The plate type unit provides more surface area for heat transfer while the cylindrical type unit is cheaper to manufacture.

Preferably, the reformer 9 and combustor 15 are integrated into the same enclosure 31 and more preferably share at least one wall, as shown in FIGS. 2-4. Preferably, but not necessarily, the reformer 9 and combustor 15 are thermally integrated with the stack(s) 3, and may be located in the same enclosure or hot box 31, but comprise separate vessels from the stack(s) 3 (i.e., external reformer configuration).

FIGS. 2A and 2B show the cross-sectional top and front views, respectively, of one of a plurality of units 201 shown in FIG. 1B. Each unit 201 contains two stacks 3, and a cylindrical reformer 9/combustor 15 subunit 210. In a preferred configuration of the unit 201, fins 209 are provided in the stack cathode exhaust conduit 10 and in the combustor 15 combustion zone 207 to assist with convective heat transfer to the reformer 9. In case where the reformer 9 shares one or more walls with the cathode exhaust conduit 10 and/or with the combustion zone 207 of the combustor 15, then the fins are provided on the external surfaces of the wall(s) of the reformer. In other words, in this case, the reformer 9 is provided with exterior fins 209 to assist convective heat transfer to the interior of the reformer 9. In addition to the cathode exhaust conduit 10, each stack 3 contains an oxidizer (i.e., air) inlet conduit 19, a fuel or anode inlet conduit 223 and a fuel or anode exhaust conduit 225.

The combustion zone 207 of the combustor 15 is located in the core of the cylindrical reformer 9. In other words, the combustor 15 comprises a catalyst containing channel bounded by the inner wall 211 of the reformer 9. In this configuration, the combustion zone 207 is also the channel for the cathode exhaust gas. The space 215 between the stacks 3 and the outer wall 213 of the reformer 9 comprises the upper portion of the stack cathode exhaust conduit 10. Thus, the reformer inner wall 211 is the outer wall of the combustor 15 and the reformer outer wall 213 is the inner wall of the upper portion of stack cathode exhaust conduit 10. If desired, a cathode exhaust opening 217 can be located in the enclosure 31 to connect the upper portion 215 of conduit 10 with the lower portions of the conduit 10. The enclosure 31 may comprise any suitable container and preferably comprises a thermally insulating material.

FIGS. 3A and 3B show the cross-sectional top and front views, respectively, of an alternative unit 202 containing two stacks 3 and a plate type reformer 9 coupled with a plate type combustor 15. In this configuration, each combustor is thermally integrated with two reformers. The configuration of the plate type reformer-combustor subunit 220 is the same as the cylindrical reformer-combustor subunit 210 shown in FIGS. 2A and 2B, except that the reformer-combustor subunit 220 is sandwich shaped between the stacks. In other words, the combustion zone 207 is a channel having a rectangular cross sectional shape which is located between two reformer 9 portions. The reformer 9 portions comprise channels having a rectangular cross sectional shape. The fins 209 are preferably located on inner 211 and outer 213 walls of the reformer 9 portions. The plate type reformer and combustion subunit 220 provides more surface area for heat transfer compared to the cylindrical unit 210 and also provides a larger cross-sectional area for the exhaust gas to pass through. Thus, in the embodiments of FIGS. 2 and 3, each unit 201 and 202 contains two stacks 3, one combustor 15 and one or two reformers 9, respectively.

FIGS. 4A and 4B show the cross-sectional top and front views, respectively, of one of a plurality of units 200 shown in FIG. 1A. The unit 200 contains one stack 3 and a plate type reformer 9 coupled with a plate type combustor 15. In this configuration, each combustor is thermally integrated with one reformer. Exhaust gas is wrapped around the reformer 9 from one side. One side of the combustion zone 207 channel faces insulation of the container or hot box 31 while the other side faces the reformer 9 inner wall 211. In this case, each unit 200 contains a single stack 3, reformer 9 and combustor 15.

A method of operating the system 1 according to a first preferred embodiment of the present invention is described with reference to FIGS. 1A and 1B.

A preheated air inlet stream is provided into the cathode inlet 19 of each of the stacks 3. The air then exits the stack 3 as a cathode exhaust stream and wraps around one or more reformers 9. The cathode exhaust stream then enters the combustion zone of the combustor 15 through conduit 10 via opening 217 and inlet 25.

The system 201 is preferably configured such that the cathode exhaust (i.e., hot air) exists on the same side of the system as the inlet of the reformer 9. For example, as shown in FIG. 2B, since the mass flow of hot cathode exhaust is the maximum at the lower end of the device, it supplies the maximum heat where it is needed, at feed point of the reformer 9 (i.e., the lower portion of the reformer shown in FIG. 2B). In other words, the mass flow of the hot air exiting the stack is maximum adjacent to the lower portion of the reformer 9 where the most heat is needed. However, the cathode exhaust and reformer inlet may be provided in other locations.

Desulfurized natural gas or another hydrocarbon fuel is also supplied from the fuel feed conduits 27 into the inlets 25 of the combustors 15. Natural gas is injected into the central combustion zone 207 of the combustor 15 where it mixes with the hot cathode exhaust. The circular or spiral fins are preferably attached to the inner 211 and outer 213 reformer walls to assist heat transfer. Heat is transferred to the outer wall 213 of the reformer 9 from the stack 3 by convection and radiation. Heat is transferred to the inner wall 211 of the reformer by convection and/or conduction from the combustion zone 207. As noted above, the reformer and combustion catalysts can either be coated on the walls or packed in respective flow channels. The exhaust stream from each of the combustors 15 then preferably enters a heat exchanger where it exchanges heat with an incoming stream being provided to one or more stacks 3.

On the fuel side, the preheated hydrocarbon fuel inlet stream and steam enter each one of the reformers 9 through inlet conduit 23 where the fuel is reformed into a reformate (i.e., a hydrogen and carbon containing gas). The reformate then enters the stack 3 anode inlet from the reformer 9 through conduit 17. The stack anode exhaust stream exists the anode outlet 225 of the stack 3 and may be provided to a heat exchanger where it preheats a stream being provided into one or more stacks 3.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

What is claimed is:

1. A fuel cell system, comprising:
a plurality of fuel cell stacks;
a plurality of reformers, wherein each reformer is adapted to reform a hydrocarbon fuel to a hydrogen containing reaction product and to provide the reaction product to at least one of the plurality of the fuel cell stacks;
a plurality of combustors, wherein each combustor is thermally integrated with at least one of the plurality of the reformers;
an independent fuel feed conduit provided into each combustor; and
one or more control devices adapted to independently control an amount of fuel being provided to each combustor through each fuel feed conduit to independently control a temperature of each combustor.

2. The system of claim 1, wherein the plurality of the fuel cell stacks comprise solid oxide fuel cell stacks.

3. The system of claim 2, wherein the one or more control devices comprise one or more flow controllers that are adapted to control fuel flow into each fuel feed conduit.

4. The system of claim 3, wherein the one or more control devices comprise:
a flow controller located in each of the plurality of the fuel feed conduits; and
a control system adapted to control the flow controllers.

5. The system of claim 4, wherein the control system comprises a computer.

6. The system of claim 1, wherein independent control of a temperature of each combustor provides independent control of a temperature of each thermally integrated reformer.

7. The system of claim 6, wherein independent control of a temperature of each reformer provides independent control of a temperature of each stack which is adapted to receive the reaction product from each temperature controlled reformer.

8. The system of claim 1, wherein the cathode exhaust of each stack is operatively connected to an inlet of at least one combustor.

9. The system of claim 1, wherein each reformer is thermally integrated with at least one of the plurality of stacks.

10. The system of claim 9, wherein each reformer is thermally integrated with one of the plurality of stacks.

11. The system of claim 9, wherein a cathode exhaust of each stack is adapted to heat at least one reformer.

12. The system of claim 9, wherein each reformer is located between one of the plurality of combustors and one of the plurality of stacks.

13. The system of claim 1, wherein each combustor is thermally integrated with one of the plurality of the reformers.

14. The system of claim 1, wherein each combustor is thermally integrated with two of the plurality of the reformers.

15. A fuel cell system, comprising:
a plurality of fuel cell stacks;
a plurality of reformers, wherein each reformer is adapted to reform a hydrocarbon fuel to a hydrogen containing reaction product and to provide the reaction product to at least one of the plurality of the fuel cell stacks;
a plurality of combustors, wherein each combustor is thermally integrated with at least one of the plurality of the reformers;
an independent fuel feed conduit provided into each combustor; and
a first means for independently controlling an amount of fuel provided to each combustor through each fuel feed conduit to independently control a temperature of each combustor.

16. The system of claim 15, wherein the plurality of the fuel cell stacks comprise solid oxide fuel cell stacks.

17. The system of claim 16, wherein the first means is also a means for independently controlling a temperature of each reformer that is thermally integrated with each combustor whose temperature is being independently controlled by the first means.

18. The system of claim 17, wherein the first means is also a means for independently controlling a temperature of each stack that is adapted to receive the reaction product from each reformer whose temperature is being independently controlled by the first means.

19. The system of claim 15, wherein each reformer is thermally integrated with at least one of the plurality of stacks.

20. The system of claim 19, wherein each reformer is thermally integrated with one of a plurality of stacks.

21. The system of claim 19, wherein the cathode exhaust of each stack is adapted to heat at least one reformer.

22. The system of claim 19, wherein each reformer is located between one of the plurality of combustors and one of the plurality of stacks.

23. The system of claim 15, wherein the cathode exhaust of each stack is operatively connected to an inlet of at least on combustor.

24. The system of claim 15, wherein each combustor is thermally integrated with one of the plurality of the reformers.

25. The system of claim 15, wherein each combustor is thermally integrated with two of the plurality of the reformers.

26. A method of operating a fuel cell system, comprising:
providing a hydrocarbon fuel to a plurality of reformers;
reforming the hydrocarbon fuel to a hydrogen containing reaction product in each of the plurality of reformers;
providing the reaction product from each reformer to one least one of a plurality of the fuel cell stacks;
providing a fuel and an oxidizer to a plurality of combustors to generate heat in the combustors;
providing the heat from each combustor to at least one of the plurality of reformers; and
independently controlling an amount of fuel provided to each combustor to independently control a temperature of each combustor.

27. The method of claim 26, wherein the plurality of the fuel cell stacks comprise solid oxide fuel cell stacks.

28. The method of claim 26, further comprising independently controlling a temperature of each reformer that is thermally integrated with each combustor whose temperature is being independently controlled.

29. The method of claim 28, further comprising independently controlling a temperature of each stack that receives the reaction product from each reformer whose temperature is being independently controlled.

30. The method of claim 26, wherein the step of independently controlling an amount of fuel provided to each combustor comprises independently controlling a plurality of flow valves using a computer.

31. The method of claim 30, further comprising detecting a temperature of each one of the plurality of stacks and independently adjusting the temperature of a first of the plurality of stacks to a desired temperature by independently adjusting a flow of fuel to a first combustor which is thermally integrated with a first reformer which provides the reaction product to the first stack.

32. The method of claim 26, wherein each reformer is thermally integrated with at least one of a plurality of stacks.

33. The method of claim 32, wherein each reformer is thermally integrated with one of the plurality of stacks.

34. The method of claim 32, further comprising heating at least one of the plurality of the reformers using a cathode exhaust of at least one of the plurality of the stacks.

35. The method of claim 32, wherein each reformer is located between one of the plurality of combustors and one of the plurality of stacks.

36. The method of claim 26, wherein each combustor is thermally integrated with one of the plurality of the reformers.

37. The method of claim 26, wherein each combustor is thermally integrated with two of the plurality of the reformers.

38. The method of claim 26, wherein the oxidizer provided into each combustor comprises a cathode exhaust of at least one of the plurality of the stacks.
